(19) United States
(12) Patent Application Publication
(10) Pub. No.: US 2013/0255475 A1
(43) Pub. Date: Oct. 3, 2013

(54) CONTROLLING AUTOMATIC ACCOMPANIMENT IN AN ELECTRONIC MUSICAL INSTRUMENT

(71) Applicant: ROLAND EUROPE SPA, Acquaviva Picena (IT)

(72) Inventors: Roberto SABINI, San Benedetto del Tronto (IT); Marco DI PAOLO, Grottammare (IT); Roberto LANCIOTTI, Ripatransone (IT)

(73) Assignee: ROLAND EUROPE SPA, Acquaviva Picena (IT)

(21) Appl. No.: 13/796,977

(22) Filed: Mar. 12, 2013

(30) Foreign Application Priority Data
Mar. 30, 2012 (IT) BO2012A000173

(51) Int. Cl. G10H 1/38

(52) U.S. Cl. CPC G10H 1/383
USPC 84/637

(57) ABSTRACT

Provided are a method, automatic accompaniment device, and electronic keyboard for controlling automatic accompaniment in an electronic musical instrument. Recognition is made of chords played on the electronic musical instruments from at least one note played on the electronic musical instrument. Automatic accompaniment is initiated in response to pressure applied to a pedal coupled to the electronic musical instrument. The automatic accompaniment automatically plays sounds of at least one instrument to accompany the playing of the electronic musical instrument. Recognition is made of a chord played based on at least one played note after initiating the automatic accompaniment and the automatic accompaniment is played in the recognized chord.

### CROSS-REFERENCE TO RELATED FOREIGN APPLICATION

This application is a non-provisional application that claims priority benefits under Title 35, United States Code, Section 119(a)-(d) from Italian Patent Application No. BO2012A000173, entitled “PIANIST MODE “, by Roberto SABINI, Marco D I PAOLO, and Roberto LANCIOTTI, filed on Mar. 30, 2012, which Italian Patent Application is incorporated herein by reference in its entirety.

### BACKGROUND OF THE INVENTION

1. Field of the Invention

The present invention relates to a method, automatic accompaniment device, and electronic keyboard for controlling automatic accompaniment in an electronic musical instrument.

2. Description of the Related Art

Most modern electronic musical instruments equipped with keyboards incorporate an automatic accompaniment function, which autonomously generates an accompaniment musical pattern that is meant to provide a harmonic and rhythmic backing to the melody played by the musician using the keyboard. The automatic accompaniment function enables the musician to have other instruments available that play together with the musician and accompany what is being played by following the same harmonic line and the best suited tempo, rhythm and musical genre. This means that once the musician has set the desired instrument, the musician can select a musical genre (e.g. a waltz) and when performing the musical chords related to a melody by pressing the keys on the keyboard, the musician will hear other instruments (bass, drums, guitar, violin, etc.) playing together while the musician plays.

To be effective, the automatic accompaniment should follow the melody played by the musician on the keyboard properly. To accomplish this, the automatic accompaniment function executes a cyclical recognition of the chords played on the keyboard by the musician and adjusts the musical accompaniment pattern to the chords played by the musician on the keyboard. In this way, the automatic accompaniment function makes the musical accompaniment pattern “play” depending on the chords played by the musician on the keyboard.

For example, U.S. Pat. Nos. 5,294,747 and 5,235,126 describe automatic accompaniment devices for electronic musical instruments equipped with keyboards, wherein the chords that a musician plays by using the keys in the keyboard are recognized in order to adapt the automatic accompaniment to the chords played by the musician.

### SUMMARY

Provided are a method, automatic accompaniment device, and electronic keyboard for controlling automatic accompaniment in an electronic musical instrument. Recognition is made of chords played on the electronic musical instruments from at least one note played on the electronic musical instrument. Automatic accompaniment is initiated in response to pressure applied to a pedal coupled to the electronic musical instrument. The automatic accompaniment automatically plays sounds of at least one instrument to accompany the playing of the electronic musical instrument. Recognition is made of a chord played based on at least one played note after initiating the automatic accompaniment and the automatic accompaniment is played in the recognized chord.

### BRIEF DESCRIPTION OF THE DRAWINGS

FIG. 1 provides a schematic view of an electronic musical instrument equipped with a keyboard having an automatic accompaniment.

FIGS. 2, 3, and 4 illustrate operations for automatic accompaniment.

### DETAILED DESCRIPTION

The overall quality of the automatic accompaniment as known in the prior art is not always excellent because when the musician presses the “SUSTAIN” pedal, an undesired gap that can be clearly perceived may occur between what the musician is playing on the keyboard and what the automatic accompaniment function plays. In the prior art, when the musician presses the “SUSTAIN” pedal the chords played by the musician are not always recognized in the most appropriate manner. This means that the automatic accompaniment function cannot always recognize accurately the latest chord played by the musician. This occurs in the prior art because the function that is supposed to recognize the chords played by the musician may not operate properly when the musician presses the “SUSTAIN” pedal and does not play the chord notes together (i.e. the musician does not press all the keys corresponding to the notes composing a chord at the same time).

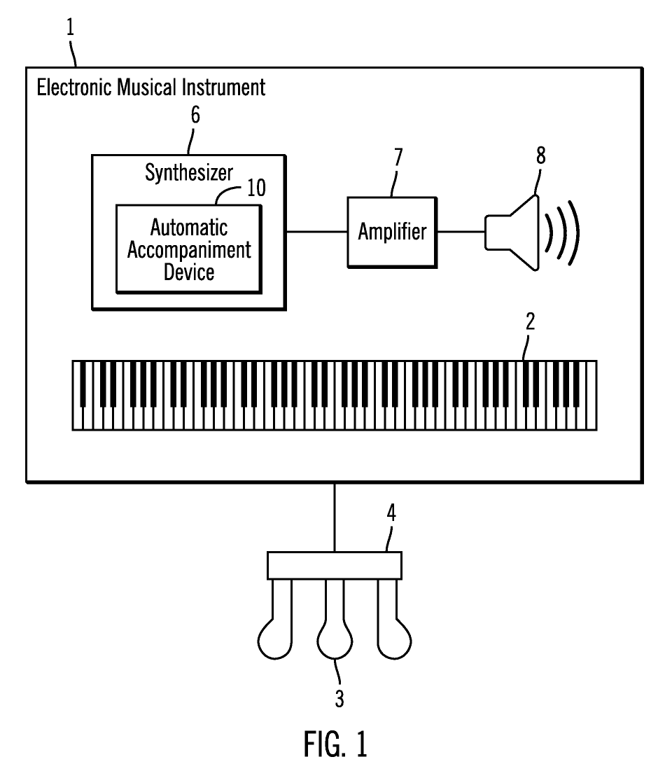

FIG. 1 shows an electronic musical instrument 1 equipped with a keyboard 2 having a plurality of keys (the keys and keyboard are referenced with the same reference numeral “2”), which are arranged in octaves and correspond to their related notes, as well as a pedal board 4 comprising a “SUSTAIN” (“SOSTENUTO”) pedal 3 at least. The pedal board 4 may have, but not limited to, three pedals to reproduce the same layout as in an acoustic piano. Alternatively, the pedal board may only have the “SUSTAIN” pedal 3.

The electronic musical instrument 1 may include a musical synthesizer 6, which receives status signals regarding the keys 2 and the “SUSTAIN” pedal 3 from the keyboard and the pedal board 4, such status signals indicating whether the keys 2 and the “SUSTAIN” pedal 3 are pressed or released and may include information about how the keys 2 have been pressed. Depending on the status signals received from the keyboard and the pedal board 4, the musical synthesizer 6 generates some sounds that are amplified by an amplifier 7, which can be either internal or external to the electronic musical instrument 1. The amplifier drives at least one speaker 8, which can be either inside or outside the musical instrument 1.

A note corresponds to every key 2 in the keyboard. Every time a key 2 in the keyboard is pressed, the musical synthesizer 6 generates (“plays”) the corresponding note. The function of the “SUSTAIN” pedal 3 usually consists in extending the notes that are played while the “SUSTAIN” pedal 3 is pressed regardless of whether the corresponding key 2 in the keyboard is released. In other words, when a key 2 in the keyboard is pressed, the musical synthesizer 6 generates (“plays”) the corresponding note, which extends in its duration (and gradually fades out if reproducing a piano sound, whereas it stays unchanged if reproducing an organ sound) as long as the key 2 is hold down. The note is rapidly stopped as soon as the key 2 is released. However, if the “SUSTAIN” pedal 3 is pressed, the note keeps on being played even if the corresponding key 2 is released as long as the “SUSTAIN” pedal 3 is kept pressed (namely the pressure on the “SUSTAIN” pedal 3 “extends” the effects of the pressed keys 2 in the keyboard).

Moreover, the electronic musical instrument 1 may also include an automatic accompaniment device 10 (which may be integrated in the musical synthesizer 6). The musician playing the electronic musical instrument 1 may turn-on the automatic accompaniment device 10 to have a musical accompaniment pattern autonomously generated, which provides a harmonic and rhythmic backing of the melody played by the musician using the keyboard 2. In other words the automatic accompaniment 10 makes other instruments available to the musician, which play together with the musician and accompany the played melodic line with the desired tempo, rhythm as well as musical genre. Once the musician has selected the desired instrument in the keyboard, the musician can select a genre (e.g. a waltz). Once the musician plays the chords related to the melody by pressing the keys 2 in the keyboard, other instruments (bass, drums, guitar, violin, etc.) will be played as an accompaniment.

When turned on, the automatic accompaniment device 10 recognizes the chords played by the musician according to the notes that are played by the musician depending on the keys 2 pressed by the musician. The automatic accompaniment device 10 may play the automatic accompaniment in the latest chord played by the musician. In one embodiment, as soon as the automatic accompaniment device 10 is turned on, it starts playing the automatic accompaniment in a default chord, which may be, but not necessarily be, the C Major chord). The default chord may be played until the musician plays a new chord, which is different from the default chord.

To recognize which chords are played by the musician, the automatic accompaniment device 10 can operate in two different methods: one chord recognition method is “standard” and it's applied when the “SUSTAIN” pedal 3 is released, the other chord recognition method is “advanced” and it's applied when the “SUSTAIN” pedal 3 is pressed. In other words, by pressing the “SUSTAIN” pedal 3, the musician makes the automatic accompaniment device 10 operate according either to the “standard” or to the “advanced” chord recognition method.

In one embodiment, the “SUSTAIN” pedal 3 may have a binary output (“ON/OFF”) such that only its pressed position (“ON”) and its released position (“OFF”) can be detected. Any kind of pressure on the “SUSTAIN” pedal 3 may turn the “SUSTAIN” function on and therefore extends the duration of the notes, while causing the automatic accompaniment device 10 to operate according to the “advanced” method.

According to an alternative embodiment, the “SUSTAIN” pedal 3 has an output with different levels indicating its position (e.g. a percentage range from 1 to 100). In this embodiment any kind of pressure on the “SUSTAIN” pedal 3 can turn the “SUSTAIN” function on and extend the duration of the notes, while causing the automatic accompaniment device 10 to operate according to the “advanced” method. In this embodiment, the “SUSTAIN” function which extends the duration of the notes and the advanced chord recognition method of the automatic accompaniment device 10 are turned-on at the same time. In an alternative embodiment, the “SUSTAIN” function extending the duration of the notes can be turned on by any kind of pressure on the “SUSTAIN” pedal 3, while the “advanced” chord recognition method of the automatic accompaniment device 10 is started only if the position of the “SUSTAIN” pedal 3 exceeds a predetermined threshold value (e.g. corresponding to 50% of the overall stroke of the “SUSTAIN” pedal 3). In other words, by pressing the “SUSTAIN” pedal 3 at the beginning only the SUSTAIN function, which extends the duration of the notes, is turned on, and only if the “SUSTAIN” pedal 3 is pressed further in its stroke, the “advanced” chord recognition method of the automatic accompaniment device 10 is started. In this way, the musician can press the “SUSTAIN” pedal 3 “a little” in order to turn the SUSTAIN function on without starting the “advanced” chord recognition method of the automatic accompaniment device 10.

The “standard” chord recognition method of the automatic accompaniment device 10 is now described (as previously explained, the “standard” chord recognition method is used when the “SUSTAIN” pedal 3 is released).

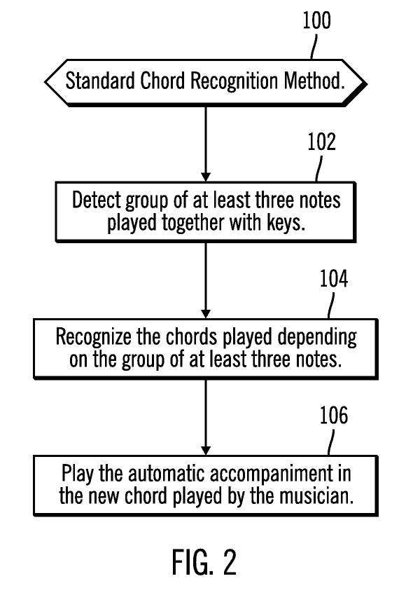

In the “standard” chord recognition method 100, described with respect to FIG. 2, the automatic accompaniment device 10 detects (at block 102) groups of at least three notes played together with the musician by pressing the corresponding keys 2 in the keyboard 2 and therefore the automatic accompaniment device 10 recognizes (at block 104) the chords played by the musician depending on the groups of at least three notes played by the musician together. In certain cases, the three notes belonging to the same chord might not be played altogether at the same time, such as if the corresponding keys 2 are not pressed at the same time. However, the three notes belonging to the same chord not played together may be played in sequence such as by pressing the corresponding keys 2 one after the other. The chord may be detected as long as all the notes of the chord are played within a certain time interval, such as the corresponding keys 2 must all be played either with a certain time span or at the same time. The automatic accompaniment device 10 may always play the automatic accompaniment according to the latest chord played by the musician. Therefore once the automatic accompaniment device 10 has recognized a new chord played by the musician, representing the latest chord played by the musician, then the automatic accompaniment device 10 plays (at block 106) the automatic accompaniment in the new chord played by the musician, which replaces the latest chord played by the musician.

The automatic accompaniment device 10 is capable of recognizing a new chord played by the musician only when the musician plays at least three notes by pressing the corresponding keys 2 in the keyboard. The musician may play more than three notes together and in such case the chord recognition occurs in accordance with all notes played by musician.

As an example, when turned on, the automatic accompaniment device 10 may start playing the automatic accompaniment in the default C Major chord (which is kept unchanged as long as the musician presses three keys 2 on the keyboard, thus playing three notes comprising a new chord. After a first time interval, during which the automatic accompaniment may be played in the default C Major chord, the musician may play three notes F-A-C (corresponding to the F Major chord) and therefore the automatic accompaniment devices 6 recognizes that the musician has played the F Major chord. From this moment onwards the automatic accompaniment is played in the F Major chord. This remains unchanged until as the musician plays another subsequent chord. After a second time interval, during which the automatic accompaniment is played in the F Major chord, the musician plays the three notes G-B-D, corresponding to the G Major chord, and the automatic accompaniment device 10 recognizes that the musician has played the G Major chord. From this second onwards, the automatic accompaniment is played in the G Major chord, which is kept unchanged until the musician plays another subsequent chord, and so on as long as the “standard” chord recognition method of the automatic accompaniment device 10 is applied.

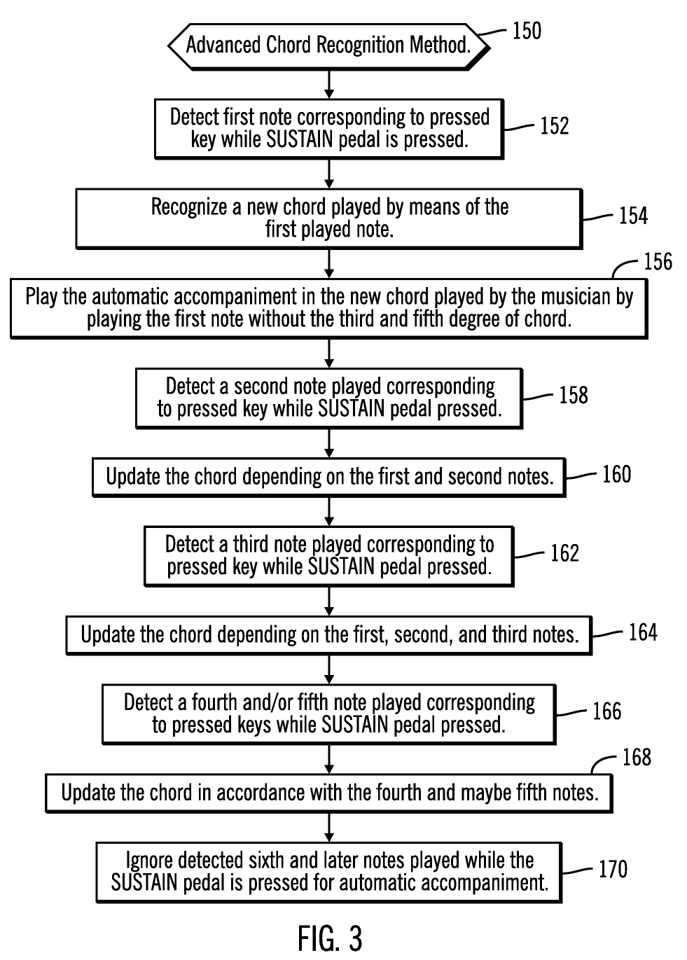

The “advanced” chord recognition method of the automatic accompaniment device 10 is described with respect to FIG. 3. The “advanced” chord recognition method may be applied when the “SUSTAIN” pedal 3 is pressed.

When the “SUSTAIN” pedal is pressed, namely when the “advanced” chord recognition method of the automatic accompaniment device 10 is turned on (at block 150), the automatic accompaniment device 10 detects (at block 152) a first note played by the musician by pressing the corresponding key 2 in the keyboard while the “SUSTAIN” pedal 3 is pressed. Therefore, as soon as the first note played by the musician is detected and without waiting for any subsequent note to be played by the musician, the automatic accompaniment device 10 recognizes (at block 154) a new chord played by the musician only by means of the first played note. The first played note may be regarded as the key note of the chord which is derived of both the third (Major/minor) and the fifth degree. This chord, which is recognized only in relation to the first played note, becomes the latest chord played by the musician and, therefore, the automatic accompaniment is immediately played according to the new latest chord played by the musician. The automatic accompaniment may be played according to the latest chord played by the musician. In other words, as soon as the first note played by the musician is detected and without waiting for any further notes subsequently played by the musician, the automatic accompaniment device 10 makes the automatic accompaniment play (at block 156) only according to the first played note. In this way, the automatic accompaniment is played in a chord, whose key note is the first played note and such chord has not either the third (Major/minor) or the fifth degree. For example, if the first note played by the musician is F, then the automatic accompaniment plays F in the key note (i.e. it plays the F chord) without third degree (Major/minor) and without fifth degree.

Once the first played note has been detected, the automatic accompaniment device 10 detects (at block 158) a second note played by the musician by pressing the corresponding key 2 in the keyboard while the musician keeps the “SUSTAIN” pedal 3 pressed. Therefore, as soon as the second note played by the musician has been detected and without waiting for any subsequent note played by the musician, the automatic accompaniment device 10 updates (at block 160) the chord depending on the first and the second played notes. The first played note may be regarded as the key note of the chord and the second played note may be regarded as additional degree of the chord. In other words, as soon as the second note played by the musician has been detected and without waiting for any other notes played by the musician to be detected, the automatic accompaniment device 10 makes the automatic accompaniment play in relation to the first and the second played note, namely the automatic accompaniment is played in a chord, whose key note is the first played note and whose additional degree is the second played note. For example, if the first note played by the musician is F and the second note played by the musician is A (F-A belong to the F Major chord), the automatic accompaniment plays in the F Major chord without fifth degree.

Once the second played note has been detected, the automatic accompaniment device 10 detects (at block 162) a third note played by the musician by pressing the corresponding key 2 in the keyboard while the musician keeps the “SUSTAIN” pedal 3 pressed. As soon as the third played note is detected the automatic accompaniment device 10 updates (at block 164) the chord played by the musician in accordance with the first, second and third note played by the musician.

Once the third played note has been detected, the automatic accompaniment device 10 detects (at block 166), if any, a fourth and maybe a fifth note played by the musician by pressing the corresponding keys 2 in the keyboard while the musician keeps the “SUSTAIN” pedal 3 pressed. Therefore the automatic accompaniment device 10 updates (at block 168) the chord played by the musician in accordance with the fourth and maybe the fifth note played by the musician, which provide additional degrees in the chord.

Once the fifth played note has been detected while the musician keeps the “SUSTAIN” pedal 3 pressed, the automatic accompaniment device 10 ignores (at block 170) any note played by the musician by pressing the corresponding keys 2 in the keyboard 2. In other words the sixth as well as any other subsequent note played by the musician do not affect the automatic accompaniment. In certain embodiments, the automatic accompaniment is affected only by the first five notes played by the musician while the musician keeps the “SUSTAIN” pedal 3 pressed.

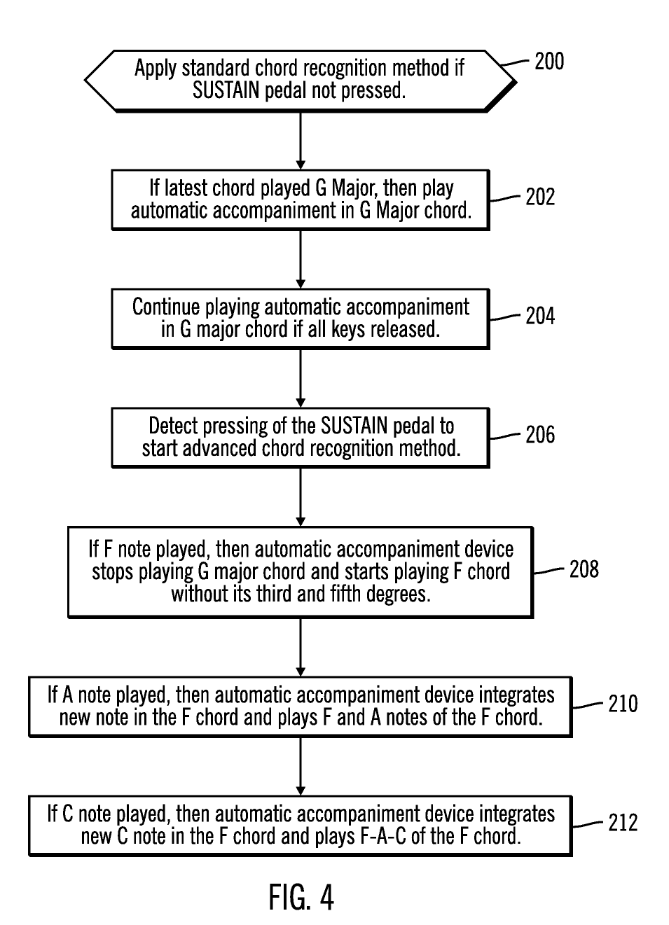

In one embodiment, as described with respect to FIG. 4, if the “SUSTAIN” pedal 3 is not pressed, then the “standard” method of chord recognition is applied (at block 200) by the automatic accompaniment device 10. In such case, if (at block 202) the latest chord played by the musician was G Major (corresponding to the notes G-B-D), then according to the “standard” chord recognition method the automatic accompaniment device 10 plays the automatic accompaniment in the G Major chord. Subsequently, if (at block 204) the musician releases all keys 2 in the keyboard, thus playing no note any longer, then the automatic accompaniment device 10 keeps on playing the automatic accompaniment in the G major chord. The musician may then press (at block 206) the “SUSTAIN” pedal to start the “advanced” chord recognition method of the automatic accompaniment device 10. After having pressed the “SUSTAIN” pedal 3, the musician plays (at block 208) the F note by pressing the corresponding key 2 in the keyboard, then the automatic accompaniment device 10 stops playing in the G major chord and starts playing in the F chord without its third (major/minor) and fifth degrees. If (at block 210) the musician then plays the A note (namely the second played note is A), then the automatic accompaniment device 10 integrates the new note in the F chord and starts playing the F major chord (the F and A notes belong to the F major chord) without its fifth degree. Upon the musician playing (at block 212) the C note (this means the third played note is C), the automatic accompaniment device 10 integrates the new note in the F major chord and starts playing the full F major chord (the F-A-C notes compose the F major chord).

In certain embodiments, while keeping the “SUSTAIN” pedal 3 pressed, after having played the first note (in the above mentioned example the note is F) by pressing the corresponding key 2 in the keyboard, the musician may release such key 2 in the keyboard either before or after having played the second note (in the above mentioned example the note is A) and/or the third note (in the above mentioned example the note is C). If the musician keeps the “SUSTAIN” pedal 3 pressed for the purpose of the automatic accompaniment, the first played note is still unchanged (in the above mentioned example it is still F). This is also the case for the second and the third played notes. In other words, according to the “advanced” chord recognition method of the automatic accompaniment device 10, it is not necessary for the musician to play the notes together, but the sequence in which they are played is determinative.

If two or more notes are played by pressing the corresponding keys 2 exactly at the same moment, then the automatic accompaniment device 10 arranges the notes, such as by deciding which notes must be played as the first one, as the second one, and so on depending on the position of the corresponding keys 2. This means that if two keys are pressed exactly at the same moment, the first played note is the note corresponding to the key 2 whose position is the farthest on the left hand side (i.e. the lowest note) and the second note is the note corresponding to the key 2 whose position is the farthest on the right hand side (i.e. the highest note).

Finally, if in the moment when the musician is already playing some notes, such as by keeping the corresponding keys 2 in the keyboard 2 pressed, then these notes that are played at the same time when the musician presses the “SUSTAIN” pedal 3, become those notes which can affect the automatic accompaniment by becoming the first, second, third notes played with the pressed “SUSTAIN” pedal 3.

With described embodiments, the “advanced” chord recognition method may not replace the “standard” chord recognition method, which can continue being used, but it replaces the “standard” chord recognition method when the “SUSTAIN” pedal 3 is pressed by the musician.

In a further embodiment, the keyboard could be split in two parts so as to assign the accompaniment function to the left part (which is played by the left hand and could be composed of the two left octaves) and the solo part to the right-hand part as well as to all the other parts.

The above described method for controlling the automatic accompaniment has several advantages. First the above described method for controlling the automatic accompaniment provides automatic accompaniment even when the musician does not play all the notes of a chord simultaneously, which is the case if the musician does not press all the keys 2 corresponding to the notes composing the chord at the same time. The automatic accompaniment is provided while the SUSTAIN pedal 3 is pressed and the musician plays all the notes of a chord in sequence and releases the previous chord when the next one is played.

In certain situations, a musician plays the instrument 1 by releasing and pressing the “SUSTAIN” pedal 3 every time the chord is changed so during performance there is usually a direct link between the “SUSTAIN” pedal 3 being pressed and the chord being changed. With the described embodiments, by starting the “advanced” chord recognition method of the automatic accompaniment device 10 upon a new chord being played, the “advanced” chord recognition method is always operated appropriately.

Furthermore, with described embodiments, the initiation of the “advanced” chord recognition method is transparent to the musician because the musician does not need to make any special operation, but can play the musical instrument 1 as usual. The musical instrument 1 will then recognize when the “SUSTAIN” pedal 3 is pressed and will automatically start the “advanced” chord recognition method of the automatic accompaniment device 10. This way, the musician can concentrate on performing the melody, while the automatic accompaniment is capable of matching the melody played by the musician fully autonomously and appropriately.

In one embodiment, when the “advanced” chord recognition method of the automatic accompaniment device 10 may be started only if the “SUSTAIN” pedal 3 is pressed beyond a predetermined threshold value. In this way, the musician may control whether the “advanced” chord recognition method of the automatic accompaniment device 10 is to be started by changing pressure applied to the “SUSTAIN” pedal 3.

Finally, the implementation of the method for controlling the above described automatic accompaniment is cost-effective because no additional high computing/storage power and hardware components are needed beyond what is usually included with an electronic musical instrument. In certain embodiments, the method for controlling the above described automatic accompaniment in an electronic musical instrument 1 may be implemented by updating the software of the automatic accompaniment device 10.

What is claimed is:

1. A method for controlling an automatic accompaniment in an electronic musical instrument, comprising:
recognizing chords played by on the electronic musical instruments from at least one note played on the electronic musical instrument;
initiating automatic accompaniment in response to pressure applied to a pedal coupled to the electronic musical instrument, wherein the automatic accompaniment automatically plays sounds of at least one additional instrument to accompany the playing of the electronic musical instrument;
recognizing a chord played based on at least one played note after initiating the automatic accompaniment; and
playing the automatic accompaniment in the recognized chord.

2. The method of claim 1, wherein the initiating the automatic accompaniment comprises:
determining whether the pressure is applied to the pedal beyond a predetermined threshold, wherein the automatic accompaniment is initiated in response to determining that the pressure is applied beyond the predetermined threshold.

3. The method of claim 2, further comprising:
extending a duration of the playing of the at least one note in response to determining that the pressure applied to the pedal is not beyond the predetermined threshold without initiating the automatic accompaniment.

4. The method of claim 1, wherein the automatic accompaniment operates according to a first automatic accompaniment method and a second automatic accompaniment method, wherein the automatic accompaniment initiated in response to the pressure applied to the pedal comprises the second automatic accompaniment method, further comprising:
using the first automatic accompaniment method to provide automatic accompaniment based on a chord played by pressing at least three notes when the pressure is not applied to the pedal to initiate the second automatic accompaniment method, and
wherein the second automatic accompaniment method provides automatic accompaniment in a chord based on a first played note without waiting for further notes of the chord to be played.

5. The method of claim 4, wherein the first automatic accompaniment method is used when pressure is not applied to the pedal.

6. The method of claim 1, wherein providing the automatic accompaniment comprises providing automatic accompaniment in response to a first played note of the chord being played without waiting for a subsequent note while the pressure is applied to the pedal, wherein the chord in which the automatic accompaniment is played is based on the first played note, wherein a key note of the chord comprises the first played note.

7. The method of claim 6, wherein the providing the automatic accompaniment comprises:
in response to detecting a second played note while the pressure continues to be applied to the pedal, updating the chord depending on the first and second played notes; and
playing the automatic accompaniment in a chord whose key note is the first played note and whose additional degree is the second played note.

8. The method of claim 7, wherein when the first and second played notes are played at a same moment, then the automatic accompaniment arranges the first and second played notes based on which note is higher than the other.

9. The method of claim 7, wherein the providing the automatic accompaniment further comprises:
in response to detecting a third played note while the pressure continues to be applied to the pedal, updating the chord depending on the first, second and third played notes; and
playing the automatic accompaniment in the chord based on the first, second and third played note.

10. The method of claim 9, wherein the providing the automatic accompaniment further comprises:
in response to detecting a fourth and fifth played note while the pressure continues to be applied to the pedal, updating the chord depending on the first, second third, fourth and fifth played notes;
playing the automatic accompaniment in the chord based on the first, second, third, fourth and fifth played notes; and
ignoring for purposes of playing the automatic accompaniment any notes detected after the fifth played note while the pressure continues to be applied to the pedal.

11. The method of claim 6, wherein the automatic accompaniment continues to play in the chord being played in response to releasing the first played note while the pressure continues to be applied to the pedal.

12. The method of claim 1, wherein providing the automatic accompaniment comprises providing automatic accompaniment in response to a first played note of the chord being played without waiting for a subsequent note while the pressure is applied to the pedal, wherein the chord in which the automatic accompaniment is played is based on the first played note, wherein a key note of the chord comprises the first played note, further comprising:
detecting a playing of a new first played note after the pedal is released; and
providing the automatic accompaniment based on the new first played note in response to applying pressure to the pedal after the pedal is released.

13. The method of claim 1, wherein the electronic musical instrument comprises an electronic keyboard and wherein the pedal comprises a sustain pedal.

14. An accompaniment device coupled to an electronic musical instrument, wherein a pedal is coupled to the electronic musical instruments, wherein the accompaniment device is configured to perform operations, the operations comprising:
recognizing chords played on the electronic musical instruments from at least one note played on the electronic musical instrument;
initiating automatic accompaniment in response to pressure applied to a pedal coupled to the electronic musical instrument, wherein the automatic accompaniment automatically plays sounds of at least one other instrument to accompany the playing of the electronic musical instrument;
recognizing a chord played based on at least one played note after initiating the automatic accompaniment; and
playing the automatic accompaniment in the recognized chord.

15. The accompaniment device of claim 14, wherein the initiating the automatic accompaniment comprises:
determining whether the pressure has been applied to the pedal beyond a predetermined threshold, wherein the automatic accompaniment is initiated in response to determining that the pressure is applied beyond the predetermined threshold.

16. The accompaniment device of claim 15, wherein the operations further comprise:
extending a duration of the playing of the at least one note in response to determining that the pressure to the pedal is applied beyond the predetermined threshold without initiating the automatic accompaniment.

17. The accompaniment device of claim 14, wherein the automatic accompaniment operates according to a first automatic accompaniment method and a second automatic accompaniment method, wherein the automatic accompaniment initiated in response to the pressure applied to the pedal comprises the second automatic accompaniment method, wherein the operations further comprise:
using the first automatic accompaniment method to provide automatic accompaniment based on a chord played by pressing at least three notes when the pressure is not applied to the pedal to initiate the second automatic accompaniment method, and
wherein the second automatic accompaniment method provides automatic accompaniment in a chord based on a first played note without waiting for further notes of the chord to be played.

18. The accompaniment device of claim 17, wherein the first automatic accompaniment method is used when pressure is not applied to the pedal.

19. The accompaniment device of claim 14, wherein providing the automatic accompaniment comprises providing automatic accompaniment in response to a first played note of the chord being played without waiting for a subsequent note while the pressure is applied to the pedal, wherein the chord in which the automatic accompaniment is played is based on the first played note, wherein a key note of the chord comprises the first played note.

20. The accompaniment device of claim 19, wherein the providing the automatic accompaniment comprises:
in response to detecting a second played note while the pressure continues to be applied to the pedal, updating the chord depending on the first and second played notes; and
playing the automatic accompaniment in a chord whose key note is the first played note and whose additional degree is the second played note.

21. The accompaniment device of claim 20, wherein when the first and second played notes are played at a same moment, then the automatic accompaniment arranges the first and second played notes based on which note is higher than the other.

22. The accompaniment device of claim 20, wherein the providing the automatic accompaniment further comprises:
in response to detecting a third played note while the pressure continues to be applied to the pedal, updating the chord depending on the first, second and third played notes; and
playing the automatic accompaniment in the chord based on the first, second and third played note.

23. The accompaniment device of claim 22, wherein the providing the automatic accompaniment further comprises:
in response to detecting a fourth and fifth played note while the pressure continues to be applied to the pedal, updating the chord depending on the first, second, third, fourth and fifth played notes;
playing the automatic accompaniment in the chord based on the first, second, third, fourth and fifth played notes; and
ignoring for purposes of playing the automatic accompaniment any notes detected after the fifth played note while the pressure continues to be applied to the pedal.

24. The accompaniment device of claim 19, wherein the automatic accompaniment continues to play in the chord being played in response to a releasing of the first played note while the pressure continues to be applied to the pedal.

25. The accompaniment device of claim 14, wherein providing the automatic accompaniment comprises providing automatic accompaniment in response to a first played note of the chord being played without waiting for a subsequent note while the pressure is applied to the pedal, wherein the chord in which the automatic accompaniment is played is based on the first played note, wherein a key note of the chord comprises the first played note, further comprising:
detecting a playing of a new first played note after the pedal is released; and
providing the automatic accompaniment based on the new first played note in response to applying pressure to the pedal after the pedal is released.

26. An electronic keyboard coupled to a pedal, comprising:
a keyboard having keys;
an accompaniment device configured to perform operations, the operations comprising:
recognizing chords played on the keyboard from at least one note corresponding to at least one of the keys played;
initiating automatic accompaniment in response to pressure applied to the pedal, wherein the automatic accompaniment automatically plays sound of at least one other instrument to accompany the playing of the keyboard;
recognizing a chord played based on at least one played note corresponding to at least one of the keys after initiating the automatic accompaniment; and
playing the automatic accompaniment in the recognized chord.

27. The electronic keyboard of claim 26, wherein the initiating the automatic accompaniment comprises:
determining whether pressure has been applied to the pedal beyond a predetermined threshold, wherein the automatic accompaniment is initiated in response to determining that the pressure to the pedal is applied beyond the predetermined threshold.

28. The accompaniment device of claim 26, wherein the automatic accompaniment operates according to a first automatic accompaniment method and a second automatic accompaniment method, wherein the automatic accompaniment initiated in response to the pressure applied to the pedal comprises the second automatic accompaniment method, wherein the operations further comprise:
using the first automatic accompaniment method to provide automatic accompaniment based on a chord played by a pressing of at least three notes when the pressure is not applied to the pedal to initiate the second automatic accompaniment method, and
wherein the second automatic accompaniment method provides automatic accompaniment in a chord based on a first played note without waiting for further notes of the chord to be played.

29. The accompaniment device of claim 28, wherein the first automatic accompaniment method is used when pressure is not applied to the pedal.

30. The accompaniment device of claim 26, wherein providing the automatic accompaniment comprises providing automatic accompaniment in response to a first played note of the chord being played without waiting for a subsequent note while the pressure is applied to the pedal, wherein the chord in which the automatic accompaniment is played is based on the first played note, wherein a key note of the chord comprises the first played note.

31. The accompaniment device of claim 30, wherein the providing the automatic accompaniment comprises:
in response to detecting a second played note while the pressure continues to be applied to the pedal, updating the chord depending on the first and second played notes; and
playing the automatic accompaniment in a chord whose key note is the first played note and whose additional degree is the second played note.

32. The accompaniment device of claim 30, wherein the automatic accompaniment continues to play in the chord being played in response to a releasing of the first played note while pressure continues to be applied to the pedal.

33. The accompaniment device of claim 26, wherein providing the automatic accompaniment comprises providing automatic accompaniment in response to a first played note of the chord being played without waiting for a subsequent note while the pressure is applied to the pedal, wherein the chord in which the automatic accompaniment is played is based on the first played note, wherein a key note of the chord comprises the first played note, further comprising:
detecting a playing of a new first played note after the pedal is released; and
providing the automatic accompaniment based on the new first played note in response to applying pressure to the pedal after the pedal is released.
